(19) United States
(12) Patent Application Publication
(10) Pub. No.: US 2024/0134934 A1
(43) Pub. Date: Apr. 25, 2024

(54) INFORMATION PROCESSING APPARATUS, INFORMATION PROCESSING METHOD AND PROGRAM

(71) Applicant: Nippon Telegraph and Telephone Corporation, Tokyo (JP)

(72) Inventors: Takaaki Moriya, Musashino-shi, Tokyo (JP); Manabu Nishio, Musashino-shi, Tokyo (JP); Taizo YAMAMOTO, Musashino-shi, Tokyo (JP); Yu MIYOSHI, Musashino-shi, Tokyo (JP)

(21) Appl. No.: 18/276,198

(22) PCT Filed: Feb. 15, 2021
(86) PCT No.: PCT/JP2021/005510

§ 371 Date: Aug. 8, 2023

(51) Int. Cl. G06F 17/18; G06F 40/20

(52) U.S. Cl. CPC G06F 17/18; G06F 40/20

(57) ABSTRACT

An information processing device 1 includes a calculation unit 13 that calculates a degree of overlapping between a probability distribution of each probability value included in a row i or a column i of a semantic similarity matrix, and a probability distribution of respective probability values included in a row j or a column j (j≠i) of the waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

### TECHNICAL FIELD

The present invention relates to an information processing device, an information processing method, and an information processing program.

### BACKGROUND ART

With current trends in big data, it is expected that many new values will be generated by the analysis of data. For example, if a large amount of data is collected from Point of Sales (POS) information and evidence including unexpected relationships which have not been found in the past are found in a large amount of data, the data can be utilized for advanced market prediction, sales strategy planning, or the like.

However, the above evidence is not easily found, and there is a possibility that unexpected relationship in the data may be overlooked. Here, it may be assumed that there is a word set composed of two words, and two pieces of time-series data corresponding to the two words are obtained. The semantic distance between two words is something that human beings subjectively feel, and it can be expected that semantically distant words will have a weaker relationship and the behavior of the pieces of time-series data thereof will not be similar. For example, because hams and automobiles are of different classes, it can be expected that price movements thereof will not be similar.

At this time, if actual time-series data (price movement in this example) resembles against prediction, there is unexpectedness. In other words, it can be considered that there is unexpectedness between two words having similar waveforms of the time-series data thereof although the meanings thereof are not similar. Therefore, between two words, an index representing a semantic similarity and an index representing a similarity of waveforms can be defined, and an index obtained by synthesizing these two indices can be defined as a degree of unexpectedness between the two words.

For example, in NPL 1, for the two words i, and j, a cosine similarity between a vector of a word i and a vector of a word j is defined as a semantic similarity u_{i,j}, a waveform similarity between time-series data related to a word i and time-series data related to a word j is defined as a waveform similarity v_{i,j}, and a distance d_{i,j} (=wᵥv_{i,j}−wᵤu_{i,j}) between the semantic similarity u_{i,j} and the waveform similarity v_{i,j} is calculated as a degree of unexpectedness. wᵥ and wᵤ are weighting coefficients.

Other index synthesis techniques include a method of performing basket analysis on the occurrence frequency of predetermined data based on a keyword (NPL 2), and a method of analyzing main components of a plurality of variables correlated with each other (NPL 3). However, the method of NPL 2 is a method for analyzing co-occurrence such as similar purchase frequency of merchandise, and it is not possible to quantitatively show the relationship between a meaning and time-series data which are different from each other. Since the method of NPL 3 is based on the assumption that there is homogeneity and correlation, it is not possible to quantify a relationship between heterogeneous data such as meaning and time-series data.

### CITATION LIST

### Non Patent Literature

[NPL 1] Moriya, et al., “A study on the gap between subjective similarity and objective similarity of words,” The Institute of Electronics, Information and Communication Engineers, 2020 Society Conference, A-10-12, September 2020

[NPL 2] Motoda, et al., “Basics of Data Mining,” Ohmsha, March 2008, p. 41-p. 43

[NPL 3] Okuda, et al., “Multivariate Analysis,” JUSE, August 1986, p. 159-p. 163

### SUMMARY OF INVENTION

### Technical Problem

In order to calculate the degree of unexpectedness between words, it is necessary to synthesize different indices for meaning and time-series data as in the case of NPL 1. However, in NPL 1, since different indices are directly calculated to create a new synthetic index, there are the following problems.

Firstly, there is susceptibility to being affected by a specific index. In NPL 1, since the waveform similarity v_{i,j} between time-series data is calculated using Dynamic Time Warping (DTW), the range of values of the waveform similarity v_{i,j} is very large. When substituting a very large value into the synthesizing formula for the distance d_{i,j}, the value of the distance d_{i,j} is strongly influenced by the index of the waveform similarity v_{i,j}, and there is a drawback that the semantic similarity u_{i,j} and the waveform similarity v_{i,j} are not treated fairly. Further, the adjustment of the weightings wᵤ and wᵥ also requires trial and error.

Secondly, it is assumed that the indices are accurate. It is difficult to quantify the similarity between waveforms of time-series data, and even if the waveform similarity is calculated using DTW, the waveform similarity v_{i,j} may not be able to be accurately quantified. If the value of the waveform similarity v_{i,j} calculated using DTW is inaccurate, the distances d_{i,j} are also inaccurate. It is also difficult to quantify a scale on which a person feels that waveforms are similar.

The third point is that the scale between indices may be different. If two different indices having different scales are synthesized in the same column, that is, if the indices for the meaning and the time-series data are synthesized in a state where the scales are different from each other, an erroneous result may be obtained. For example, adding or subtracting raw values of a height and a weight has no meaning.

The present invention has been made in view of the above circumstances, and an object of the present invention is to provide a technique capable of appropriately synthesizing a plurality of heterogeneous indices.

### Solution to Problem

An information processing device of an aspect of the present invention includes a calculation unit that calculates a degree of overlapping between a probability distribution of each probability value included in a row i or a column i of a semantic similarity matrix, and a probability distribution of respective probability values included in a row j or a column j (j≠i) of the waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

An information processing device of an aspect of the present invention includes a calculation unit that calculates, in a case where a plurality of semantic similarities included in a semantic similarity matrix and a plurality of waveform similarities included in a waveform similarity matrix each follow a normal distribution or a Poisson distribution, a synthesized value of standardized variable values of the semantic similarity of a row i and a column j of the semantic similarity matrix and standardized variable values of the waveform similarity of a row i and a column j of the waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

An information processing method of an aspect of the present invention is an information processing method performed by an information processing device, the method including a step of calculating a degree of overlapping between a probability distribution of each probability value included in a row i or a column i of a semantic similarity matrix, and a probability distribution of respective probability values included in a row j or a column j (j≠i) of the waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

An information processing method of an aspect of the present invention is an information processing method performed by an information processing device, the method including a step of calculating, in a case where a plurality of semantic similarities included in a semantic similarity matrix and a plurality of waveform similarities included in a waveform similarity matrix each follow a normal distribution or a Poisson distribution, a synthesized value of standardized variable values of the semantic similarity of a row i and a column j of the semantic similarity matrix and standardized variable values of the waveform similarity of the row i and the column j of the waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

An information processing program according to one aspect of the present invention causes a computer to function as the information processing device.

### Advantageous Effects of Invention

According to the present invention, it is possible to provide a technology capable of appropriately synthesizing a plurality of heterogeneous indices.

### BRIEF DESCRIPTION OF DRAWINGS

FIG. 1 is a reference diagram for illustrating an outline of the invention.

FIG. 2 is a diagram illustrating a functional block configuration of an information processing device according to a first embodiment.

FIG. 3 is a diagram illustrating a calculation processing flow of a degree of unexpectedness according to the first embodiment.

FIG. 4 is a reference diagram for illustrating the calculation processing flow of FIG. 3.

FIG. 5 is a diagram illustrating a conversion processing flow for converting raw values of a similarity matrix into probability values.

FIG. 6 is a reference diagram for illustrating the conversion processing flow of FIG. 5.

FIG. 7 is a diagram for illustrating the effects of the first embodiment.

FIG. 8 is a diagram illustrating a functional block configuration of an information processing device according to a second embodiment.

FIG. 9 is a diagram illustrating a calculation processing flow of a degree of unexpectedness according to the second embodiment.

FIG. 10 is a reference diagram for illustrating the calculation processing flow of FIG. 9.

FIG. 11 is a reference diagram for synthesizing three indices.

FIG. 12 is a reference diagram for illustrating a third embodiment.

FIG. 13 is a reference diagram for illustrating the third embodiment.

FIG. 14 is a diagram illustrating a hardware configuration of the information processing device.

### DESCRIPTION OF EMBODIMENTS

Herein below, a description will be given of an embodiment of the present invention with reference to the drawings. Parts in the drawings which are the same will be designated by the same reference characters and descriptions thereof will be omitted accordingly.

### 1. Outline of Invention

In order to solve the above problems, the present invention discloses two methods.

Here, it is assumed that there is a semantic similarity matrix U having a semantic similarity of the i-th and j-th word sets (i,j) as elements, and a waveform similarity matrix V having a waveform similarity v_{i,j} of the word sets (i,j) as elements. The semantic similarity u_{i,j} is a raw value of a cosine similarity between the vector of the word i and the vector of the word j. The raw values are numerical values (for example, 0.2) expressing a distributed expression of words obtained by analyzing a document or the like by word 2vec, and are values subjected to general preprocessing such as removal of outliers and logarithmic transformation. The waveform similarity v_{i,j} is a raw value obtained by calculating a waveform similarity between the time-series data related to the word i and the time-series data related to the word j by using DTW, such as the waveform similarity of the time-series data related to price variation. Instead of DTW, a value obtained by indexing the similarity between two pieces of time-series data, such as a correlation coefficient, by a known method may be used. At this time, the degree of unexpectedness between rice and cucumber is calculated as follows.

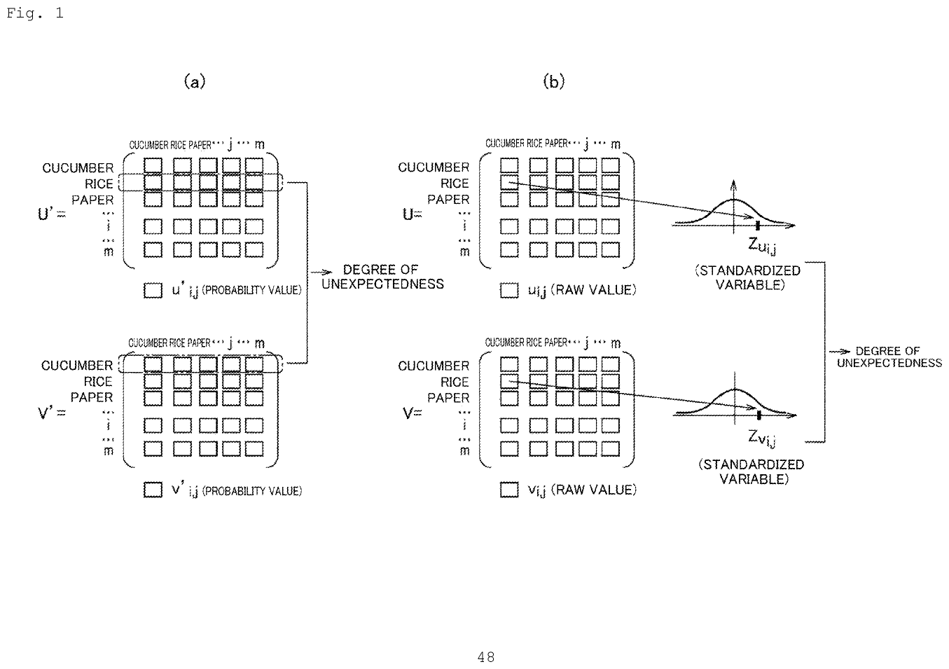

The first method is a method for calculating the degree of unexpectedness based on the shape of each distribution of rice and cucumber captured in a row unit or a column unit. First, raw values of a semantic similarity u_{i,j} included in the semantic similarity matrix U are converted into probability values in one row or in one column, and raw values of waveform similarity v_{i,j} included in the waveform similarity matrix V are similarly converted into probability values. Next, using a semantic similarity matrix U′ having a semantic similarity u′_{i,j} of the probability value after conversion as an element and a waveform similarity matrix V′ having a waveform similarity v′_{i,j} of the probability value after conversion as an element, the similarity (the degree of overlapping of the distribution) between rice and cucumber is defined as the degree of unexpectedness between rice and cucumber, using the similarity between the shape of the probability distribution of the rice row of the semantic similarity matrix U′ and the shape of the probability distribution of the cucumber row of the waveform similarity matrix V′ (refer to FIG. 1(a)).

The second method is a method for calculating the unexpectedness based on the standardized variable value of the element in the normal distribution or the Poisson distribution. First, it is assumed that the raw values of the semantic similarities u_{i,j} included in the semantic similarity matrix U follow a normal distribution, and the raw values of the waveform similarities v_{i,j} included in the waveform similarity matrix V also follow the normal distribution. Next, a standardized variable value Zv_{rice, cucumber} of rice and cucumber in the semantic similarity matrix U is obtained. Similarly, a standardized variable value Zv_{rice, cucumber} of rice and cucumber in the waveform similarity matrix V is obtained. Thereafter, the value obtained by synthesizing the standardized variable value Zu_{rice, cucumber} and the standardized variable value Zv_{rice, cucumber} is defined as a degree of unexpectedness between rice and cucumber (refer to FIG. 1(b)).

The first method and the second method use distribution information (standardized variable values assumed to follow probability distribution, normal distribution or Poisson distribution) of each element of the semantic similarity matrix U and the waveform similarity matrix V when synthesizing different indices such as semantic and time-series data, so that a phenomenon that either semantic similarity or waveform similarity is strongly affected can be suppressed. As a result, a technique capable of appropriately synthesizing a plurality of different indices can be provided.

### 2. First Embodiment

The first embodiment describes the first method.

### 2.1. Configuration of Information Processing Device

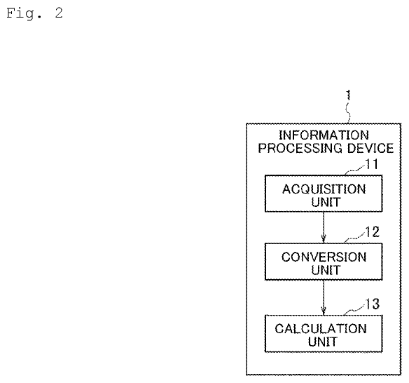

FIG. 2 is a diagram illustrating a functional block configuration of an information processing device 1 according to a first embodiment. The information processing device 1 is an index synthesis device for synthesizing an index representing semantic similarity of a word and an index representing waveform similarity of time-series data related to the word, and is an unexpectedness degree calculation device for calculating an index value after synthesis as a degree of the unexpectedness. The information processing device 1 includes an acquisition unit 11, a conversion unit 12, and a calculation unit 13.

The acquisition unit 11 is a functional unit for acquiring a semantic similarity matrix U having, as an element, semantic similarity u_{i,j} of the i-th and j-th word sets (i,j) read from a storage unit of the information processing device 1, the Internet, or the like, or input by a user. The acquisition unit 11 is a functional unit for acquiring a waveform similarity matrix V having waveform similarities v_{i,j} of the word set (i,j) as elements.

The conversion unit 12 is a functional unit that converts raw values of all semantic similarities u_{i,j} included in the semantic similarity matrix U into probability values in one row or in one column, and generates a semantic similarity matrix U′ having the semantic similarity u′_{i,j} of the probability values as elements. The conversion unit 12 is a functional unit that converts raw values of all waveform similarities v_{i,j} included in the waveform similarity matrix V into probability values in one row or in one column, and generates a waveform similarity matrix V′ having the waveform similarity v′_{i,j} of the probability values as elements.

The calculation unit 13 is a functional unit that uses the semantic similarity matrix U′ and the waveform similarity matrix V′ to calculate the degree of overlapping of the probability distribution of respective probability values included in row is or column is of the semantic similarity matrix U′ and the probability distribution of respective probability values included in row js or column js (j≠i) of the waveform similarity matrix V′ as the unexpectedness of the i-th and j-th words.

### 2.2. Operation of Information Processing Device

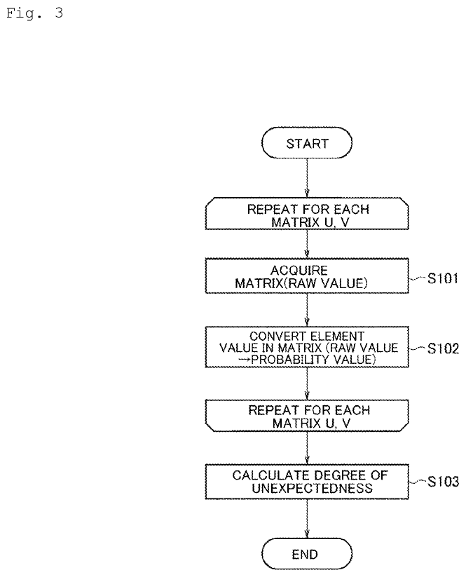

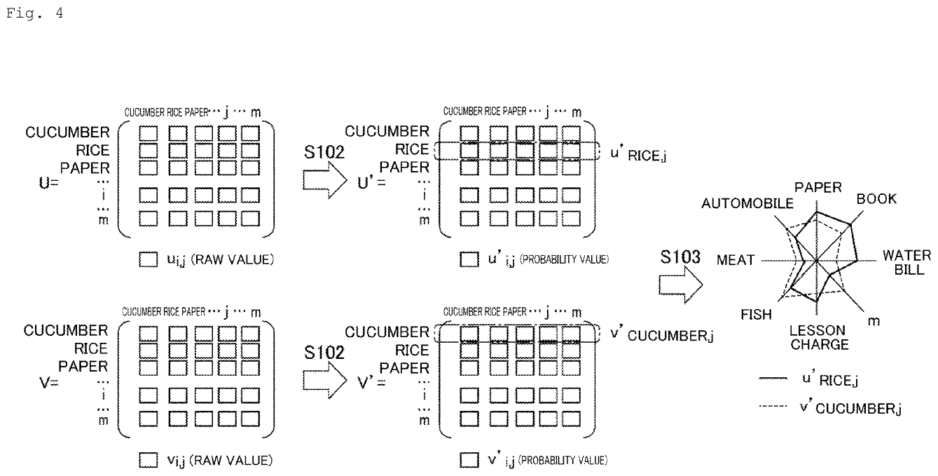

FIG. 3 is a diagram illustrating a calculation processing flow of a degree of unexpectedness according to the first embodiment. FIG. 4 is a reference diagram for illustrating the calculation processing flow.

### Step S101:

First, the acquisition unit 11 acquires the semantic similarity matrix U having semantic similarity u_{i,j} as an element. As described above, the semantic similarity u_{i,j} is a raw value of the cosine similarity between the vector of the word i and the vector of the word j. The raw value is a numerical value (for example, 0.2) expressed by a distributed expression of words obtained by analyzing a document or the like by a word2vec, and is a value obtained by performing general preprocessing such as removal of an outlier and logarithmic transformation.

### Step S102;

Next, the conversion unit 12 converts raw values of all semantic similarities u_{i,j} included in the semantic similarity matrix U into a probability value with the whole row set to 1 for each row, and generates a semantic similarity matrix U′ with the semantic similarity u′_{i,j} of the probability value as an element. The method of converting the raw value to the probability value will be described later.

The information processing device 1 also executes steps S101 and S102 for the waveform similarity matrix V having the waveform similarities v_{i,j} as elements. Thus, a waveform similarity matrix V′ having the waveform similarity v′_{i,j} of the probability value as an element is also generated.

### Step S103;

Finally, the calculation unit 13 takes out, for example, semantic similarity u′_{rice,j} (1≤j≤m) of the rice row from the semantic similarity matrix U′, and obtains each probability value of the semantic similarity u′_{rice,j} of the rice row. Similarly, the calculation unit 13 extracts, for example, the waveform similarity v′_{cucumber,j} (1≤j≤m) of the cucumber row from the waveform similarity matrix V′, and obtains each probability value of the waveform similarity v′_{cucumber,j} of the cucumber row. Thereafter, the calculation unit 13 quantifies the degree of overlapping between the probability distribution of the semantic similarity u′ of the rice row and the probability distribution of the waveform similarity v′ of the cucumber row and the probability distribution of the waveform similarity v′ of the cucumber row by quantifying the Kullback-Leibler divergence equation (1) and sets the quantified value as the degree of unexpectedness between rice and cucumber. When the semantic similarity u′_{rice,j} on the rice row and the waveform similarity v′_{cucumber,j} on the cucumber column are plotted on one radar chart as illustrated in FIG. 4, the overlapping degree of the both corresponds to the degree of unexpectedness r_{rice, cucumber.} Finally, the calculation unit 13 obtains an unexpectedness degree matrix R having the unexpectedness r_{i,j} as elements.

$$\begin{matrix}[ Math . 1 ] & \\ D ( {V}_{Cucumber}^{′} ‖ {U}_{Rice}^{′} ) = {\sum }_{j = 1}^{m} {v}_{Cucumber , j}^{′} log \frac{{v}_{Cucumber , j}^{′}}{{u}_{Rice , j}^{′}} & ( 1 )\end{matrix}$$

Expression (1) is a mathematical expression for indexing a similarity between the distribution of the semantic similarity u′_{rice,j} of the rice row and the distribution of the waveform similarity v′_{cucumber,j} of the cucumber row. It is an image of calculating the similarity between the semantic vector of rice relatively obtained in the entire vocabulary and the waveform vector of cucumber relatively obtained in the entire vocabulary. The smaller the value of D, the more similar the distribution. When u′=v′ is established, the value of D is minimized. The degree of overlapping between “the tendency of meaning” and “the tendency of waveform” in the whole vocabulary is quantified. The closer the both are, the more the distribution shapes are overlapped, and the more the meaning of rice and the tendency of the waveform of cucumber are similar.

In the above step S103, the case of calculating D(V′_{cucumber|}|U′_{rice}) was described, but a similar effect can be obtained by calculating D(U′_{cucumber}∥V′_{rice}), D(V′_{rice}∥U′_{cucumber}), and D(U′_{rice}∥V′_{cucumber}). As for the probability value, the probability value may be calculated in units of columns with the whole of one column as 1.

### 2.3. Operation of Conversion Processing

A method of converting the raw value to the probability value in the step S102 will be described. The method of converting the raw value into the probability value may be, for example, a method using relative frequency as follows. In addition, any method may be used.

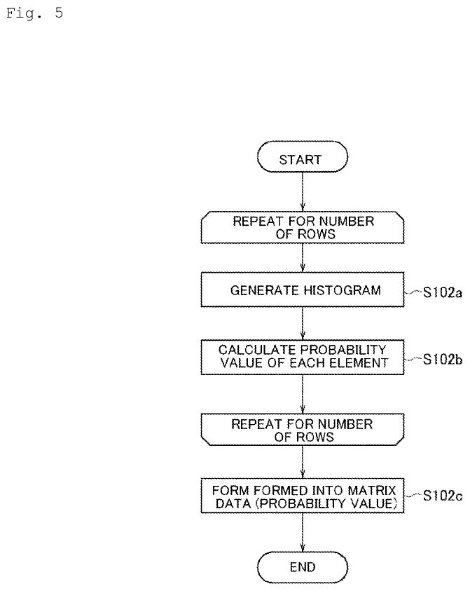

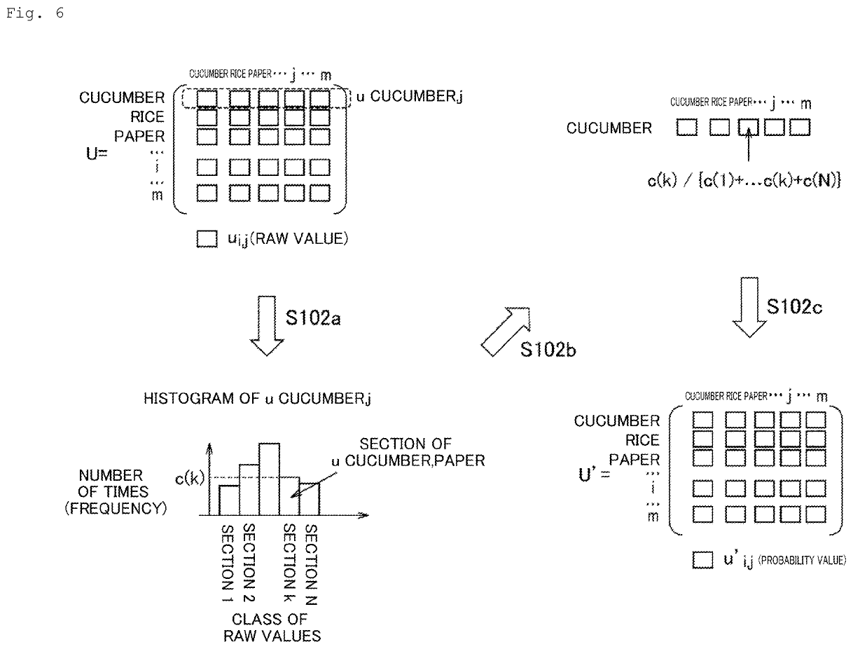

FIG. 5 is a diagram illustrating a conversion processing flow for converting a raw value of a similarity matrix into a probability value. FIG. 6 is a reference diagram for illustrating the conversion processing flow.

### Step S102a;

First, the conversion unit 12 extracts raw values of a semantic similarity u_{cucumber,j} on the cucumber row from a semantic similarity matrix U, a histogram is generated in which the horizontal axis is defined as the class of the raw value and the vertical axis is defined as the number of times of the raw value.

### Step S102b;

Then, the conversion unit 12 calculates probability values of respective semantic similarity u_{cucumber,j} (1 j m) with the whole cucumber row as 1 by using the histogram. For example, in a case where the semantic similarity u_{cucumber,paper} belong to the class of a section k and the section k is the number of times c(k), the value of [c(k)/{c(1)+ . . . +c(k)+c(N)}] is set to probability values of the semantic similarity u_{cucumber,paper}.

The information processing device 1 executes the steps S102a and S102b also for rows other than cucumber rows included in the semantic similarity matrix U.

### Step S102c;

Finally, the conversion unit 12 returns the probability values of all the rows of the semantic similarity u_{cucumber,j} to the matrix of mm, and obtains the semantic similarity matrix U of the probability values.

The raw values of the waveform similarities v_{i,j} are also converted into probability values by the same procedure.

### 2.4. Effects of First Embodiment

In the first embodiment, since the same scale of probability distribution is used for the semantic similarity u_{i,j}) and the waveform similarity v_{i,j}, influence on a specific index can be suppressed. Further, since the adjustment parameter of the weight is not used, the adjustment of the weight can be made unnecessary.

In the first embodiment, since each element of the semantic similarity u_{i,j} and the waveform similarity v_{i,j} is converted into a probability value, the range of values which can be taken by the semantic similarity u_{i,j} and the waveform similarity v_{i,j} can be narrowed, and the value of an abnormal value can be reduced. As a result, the assumption that the index is accurate can be eliminated.

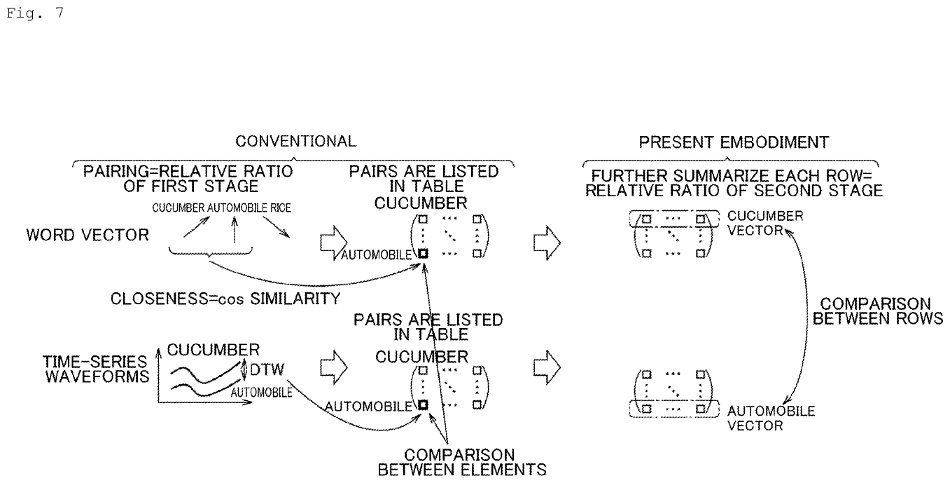

Further, in the first embodiment, the influence of individual values is reduced since the data are captured in units of rows. In this respect, in NPL 1, the difference (difference between elements) between the semantic similarity u_{i,j} obtained by pairing the word vector of the word i and the word vector of the word j (first-stage relative) and the waveform similarity v_{i,j} obtained by pairing the time-series data of the word i and the time-series data of the word j (first-stage relative) is set as the degree of unexpectedness (referred to the “prior art” of FIG. 7). On the other hand, in the first embodiment, the degree of unexpectedness is calculated based on the semantic similarity u collected in the unit of row or column (the second-stage relative) and the waveform similarity v collected in the unit of row or column (the second-stage relative) (refer to the present embodiment of FIG. 7). As compared with NPL 1, since the relative relationship is further performed, there is an effect of reducing the dependency on the semantic similarity u_{i,j} and the waveform similarity v_{i,j} and the accuracy requirement. As a result, the assumption that the index is accurate can be eliminated.

In the first embodiment, since each element of the semantic similarity u_{i,j} and the waveform similarity v_{i,j} is converted into a probability value, even when the scales between the indices are different, the synthesis can be properly performed.

Thus, a technique capable of appropriately synthesizing a plurality of different indices can be provided. The user can automatically calculate the accurate unexpectedness without knowing the theoretical background, thereby ensuring security. Since the degree of unexpectedness for a person is sensuous, it is difficult to evaluate, the results can be compared and used for verification by using the unexpectedness algorithm described in the first embodiment. In the future, the relative superiority or inferiority of the algorithm is evaluated by majority decision.

### 3. Second Embodiment

The second method will be described in the second embodiment. As described at the beginning, in the second embodiment, assuming that each element (i,j) of the semantic similarity matrix U and the waveform similarity matrix V follows a normal distribution or a Poisson distribution, the average value and dispersion value of the normal distribution or the Poisson distribution are explicitly given. Alternatively, the data are automatically calculated from a sample, converted into a standardized variable value Z of a standard normal distribution, synthesized and inversely converted into a raw value, and defined as the unexpectedness of the word set (i,j).

### 3.1. Configuration of Information Processing Device

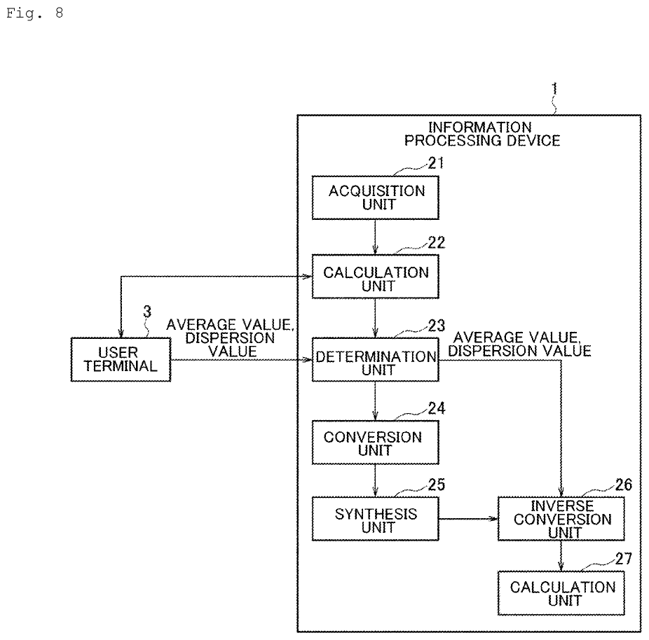

FIG. 8 is a diagram illustrating a functional block configuration of the information processing device 1 according to the second embodiment. The information processing device 1 is also an index synthesis device and is an unexpectedness degree calculation device. The information processing device 1 includes an acquisition unit 21, a calculation unit 22, a determination unit 23, a conversion unit 24, a synthesis unit 25, an inverse conversion unit 26, and a calculation unit 27.

The acquisition unit 21 is a functional unit for acquiring a semantic similarity matrix U including, as an element, semantic similarity u_{i,j} of the i-th and j-th word sets (i,j) read from a storage unit of the information processing device 1, the Internet, or the like, or input by a user. The acquisition unit 21 is a functional unit for acquiring a waveform similarity matrix V having waveform similarities v_{i,j} of the word set (i,j) as elements.

The calculation unit 22 is a functional unit for calculating a histogram of the semantic similarity u_{i,j} in the semantic similarity matrix U. The calculation unit 22 is a functional unit for calculating a histogram of the waveform similarities v_{i,j} in the waveform similarity matrix V.

The determination unit 23 is a functional unit that displays a histogram of the semantic similarity u_{i,j} on a user terminal 3 and inquires of the user whether the semantic similarity u_{i,j} follows a normal distribution or a Poisson distribution. The determination unit 23 is a functional unit that displays a histogram of the waveform similarities v_{i,j} on the user terminal 3 and inquires of the user whether the waveform similarities v_{i,j} follow a normal distribution or a Poisson distribution. If the semantic similarity u_{i,j} and the waveform similarity v_{i,j} follow the normal distribution or the Poisson distribution without inquiring the user, the functional unit may be omitted.

The determination unit 23 is a functional unit for determining an average value μᵤ and a dispersion value σᵤ of the normal distribution or the Poisson distribution related to the semantic similarity matrix U when the semantic similarity u_{i,j} follows the normal distribution or the Poisson distribution. The determination unit 23 is a functional unit for determining an average value μᵥ and a dispersion value σᵥ of the normal distribution or the Poisson distribution related to the waveform similarity matrix V when the waveform similarity v_{i,j} follows the normal distribution or the Poisson distribution.

The determination unit 23 is a functional unit for determining an average value μᵤ and a dispersion value σᵤ related to the semantic similarity matrix U and an average value μᵥ and a dispersion value σᵥ related to the waveform similarity matrix V, which are externally input from the user terminal 3, as the average value and the dispersion value to be used. The determination unit 23 is a functional unit for calculating an average value and a dispersion value of each of the semantic similarity matrix U and the waveform similarity matrix V, and determining the average value and the dispersion value to be used.

The conversion unit 24 is a functional unit for converting raw values of a semantic similarity u_{i,j} included in the semantic similarity matrix U into standardized variable values Zu_{i,j} using the average value μᵤ and the dispersion value σᵤ related to the semantic similarity matrix U. The conversion unit 24 is a functional unit that converts raw values of waveform similarities v_{i,j} included in the waveform similarity matrix V into standardized variable values Zv_{i,j} using the average value μᵥ and the dispersion value σᵥ related to the waveform similarity matrix V.

The synthesis unit 25 is a functional unit for synthesizing the standardized variable value Zu_{i,j} of the semantic similarity u_{i,j} and the standardized variable values Zv_{i,j} of the waveform similarity v_{i,j}.

The inverse conversion unit 26 uses an average value μᵤ and a dispersion value σᵤ related to the semantic similarity matrix U and an average value μᵥ and a dispersion value σᵥ related to the waveform similarity matrix V to convert the synthesized values Zr_{i,j} after synthesis which are standardized variable values (average 0, dispersion 1) into a non-standardized variable value (non-standardized variable value (non-average 1, non-dispersion 1).

The calculation unit 27 is a functional unit for calculating, in a case where a plurality of semantic similarities u_{i,j} included in the semantic similarity matrix U and a plurality of waveform similarities v_{i,j} included in a waveform similarity matrix V each follow a normal distribution or a Poisson distribution, a synthesized value of standardized variable values of the semantic similarity of the row i and the column j of the semantic similarity matrix U and standardized variable values Zv_{i,j} of the waveform similarity of the row i and the column j of the waveform similarity matrix V as a degree of unexpectedness r_{i,j} between the i-th word and the j-th word obtained by the inverse conversion unit 26 using the semantic similarity matrix U and the waveform similarity matrix V.

### 3.2. Operation of Information Processing Device

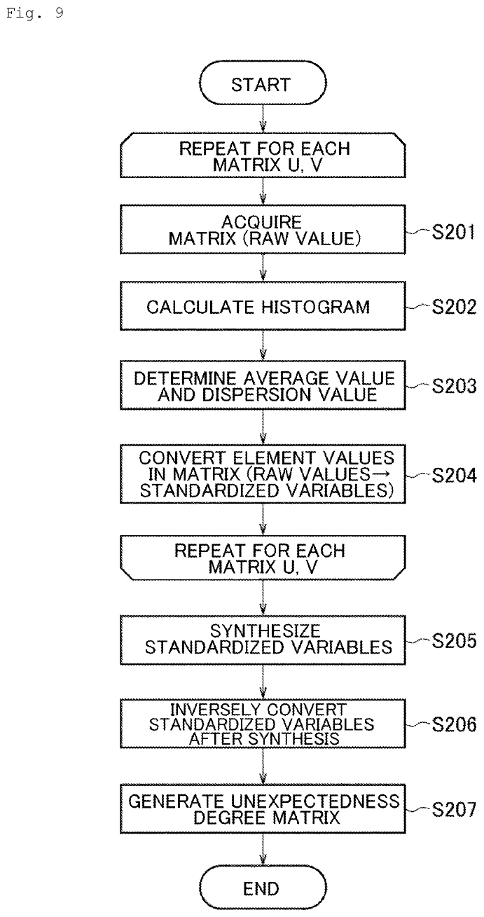

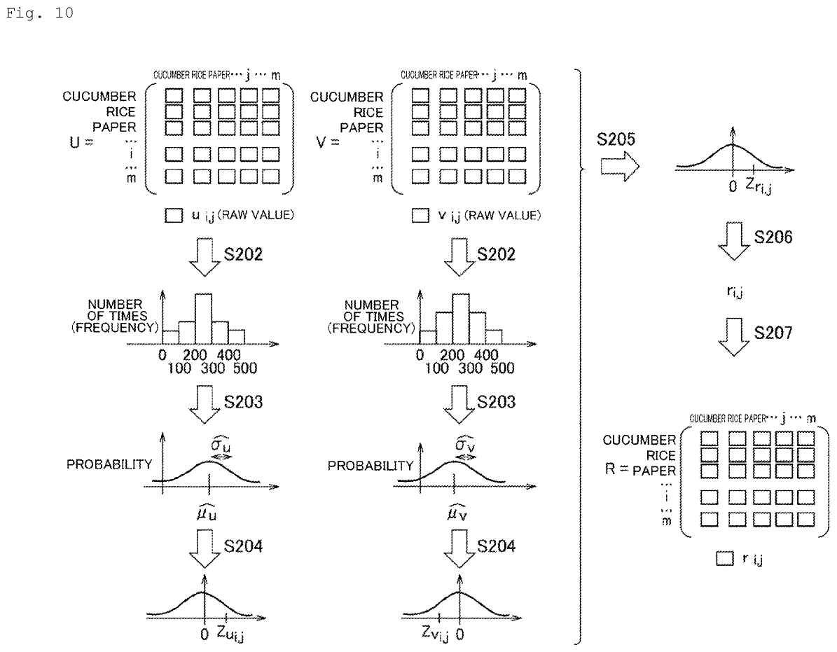

FIG. 9 is a diagram illustrating a calculation processing flow of a degree of unexpectedness according to the second embodiment. FIG. 10 is a reference diagram for illustrating the calculation processing flow.

### Step S201;

First, the acquisition unit 11 acquires the semantic similarity matrix U having semantic similarity u_{i,j} as an element. As described above, the semantic similarity u_{i,j} is a raw value of the cosine similarity between the vector of the word i and the vector of the word j. The raw value is a numerical value (for example, 0.2) expressed by a distributed expression of words obtained by analyzing a document or the like by a word2vec, and is a value obtained by performing general preprocessing such as removal of an outlier and logarithmic transformation.

### Step S202;

Next, the calculation unit 22 calculates, with respect to semantic similarity u_{i,j} (1≤i≤m, 1≤j≤m) in the semantic similarity matrix U, a histogram with the vertical axis as the number of times of the raw value is calculated. In the first embodiment, the histogram is considered in units of rows or columns, but in the second embodiment, the histogram is considered in the whole matrix, and mm pieces are the sum of the number of times. In addition, when the matrix is a symmetric matrix, for example, “waveform similarity between rice and cucumber” and “waveform similarity between cucumber and rice” become the same value, and since a diagonal row of the matrix is not, for example, “waveform similarity between rice and rice””, the number of elements obtained by removing a symmetrical component (diagonal component) from the upper triangular matrix or the number of elements obtained by removing a symmetrical component from the lower triangular matrix, that is, the sum of the number of times, such as ₘC₂=m(m−1)/2.

Thereafter, the determination unit 23 displays the histogram of the semantic similarity u_{i,j} on the user terminal 3, and inquires of the user whether or not the semantic similarity u_{i,j} conforms to a normal distribution (Poisson distribution can also be used). When the semantic similarity u_{i,j} follows the normal distribution, the process proceeds to the following processing, and when the semantic similarity u_{i,j} does not follow the normal distribution, the processing is ended without executing the following processing.

### Step S203;

When the semantic similarity u_{i,j} follows the normal distribution, the determination unit 23 requests a user to input an average value μᵤ and the dispersion value σᵤ of the semantic similarity u_{i,j} as external parameters, the average value μᵤ and the dispersion value σᵤ input by the user are determined as the average value μᵤ and the dispersion value σᵤ of the semantic similarity u_{i,j} to be used.

At this time, since the population of the semantic similarities u_{i,j} follows the normal distribution, the determination unit 23 may automatically calculate the average value μᵤ and the dispersion value σᵤ by the maximum likelihood method mechanically using the histogram of the semantic similarities u_{i,j}. In this case, the average value μᵤ and the dispersion value σᵤ are a sample average and a sample dispersion of the semantic similarity u_{i,j} (1≤i≤m, 1≤j≤m).

In a case where the average value μᵤ and the dispersion value σᵤ are externally input, there is a merit that these values can be freely set. On the other hand, when the average value μᵤ and the dispersion value σᵤ are automatically calculated, the degree of unexpectedness can be automatically calculated thereafter only by giving the semantic similarity matrix U and the waveform similarity matrix V, and there is a merit that the adjustment of the weight is not required.

### Step S204;

Next, the conversion unit 24 obtains a standardized variable value Zu_{i,j} of the semantic similarity u_{i,j} by applying the conversion formula of Expression (2) for each semantic similarity u_{i,j} (1≤i≤m, 1≤j≤m) of the semantic similarity matrix U using the average value μᵤ and the dispersion value σᵤ of the semantic similarity u_{i,j}.

$$\begin{matrix}[ Math . 2 ] & \\ {Z}_{{u}_{ij}} = \frac{{u}_{ij} -}{} & ( 2 )\end{matrix}$$

When the distribution of the semantic similarity u_{i,j} follows the logarithmic normal distribution, the conversion unit 24 may apply the conversion formula of Expression (3) sandwiching a logarithm to the semantic similarity u_{i,j} of Expression (2).

$$\begin{matrix}[ Math . 3 ] & \\ {Z}_{{u}_{ij}} = \frac{log ( {u}_{ij} ) -}{} & ( 3 )\end{matrix}$$

The information processing device 1 executes steps S201 to S204 even for a waveform similarity matrix V having waveform similarities v_{i,j} as elements. Thus, the standardized variable values Zv_{i,j} of the waveform similarities v_{i,j} are also obtained.

### Step S205;

Next, the synthesis unit 25 synthesizes the standardized variable value Zu_{i,j} of the semantic similarity u_{i,j} and the standardized variable values Zv_{i,j} of the waveform similarity v_{i,j} by applying the synthesizing formula of Expression (4) to obtain synthesized values Zr_{i,j} (1≤i≤m, 1≤j≤m).

[Math. 4]

Zᵣ_{ᵢⱼ}=Zᵥ_{ᵢⱼ}−Zᵤ_{ᵢⱼ} (4)

### Step S206;

Next, the inverse conversion unit 26 applies the inverse conversion equation of Expression (5) to each of the synthesized values Zr_{i,j} (1≤i≤m, 1≤j≤m) to obtain the degree of unexpectedness r_{i,j}.

[Math. 5]

rᵢⱼ= [symbol] Zᵣ_{ᵢⱼ}+ [symbol] (5)

However, the parameters (σr, μr) of Expression (5) are calculated by using the average value μᵤ and the dispersion value σᵤ of the semantic similarity u_{i,j} determined in the step S203, using the average value μᵥ and the dispersion value σᵥ of the waveform similarities v_{i,j}, automatically applying Expression (6) for calculating an average value of unexpectedness and Expression (7) for calculating a dispersion value of the unexpectedness.

[Math. 6]

[symbol]

= [symbol] − [symbol] (6)

[Math. 7]

[symbol]

= [symbol] + [symbol] (7)

### Step S207;

Finally, the calculation unit 27 obtains an unexpectedness degree matrix R whose elements are the degree of unexpectedness r_{i,j} (1≤i≤m, 1≤j≤m).

The calculation unit 27 may set the synthesized values Zr_{i,j} obtained in the step S205 before applying Expression (5) as the degree of unexpectedness r_{i,j}, or may set the “integral value of the synthesized values Zr_{i,j} from -” of the density function of the standard normal distribution before inverse conversion as the unexpectedness r_{i,j}.

### 3.3. Modified Example of Operation of Information Processing Device

In the calculation of the degree of unexpectedness, a case where two indices, an index of a semantic similarity and an index of waveform similarity, are synthesized has been described as an example. On the other hand, in the second embodiment, three or more indicators can be synthesized. Also, the normal distribution obtained by adding and subtracting the normal distributions becomes the normal distribution. Especially, as for the index of the waveform similarity, for example, the similarity related to the time-series data of the price variation, the similarity related to the time-series data of the stock price variation, a plurality of kinds of waveform similarities are assumed.

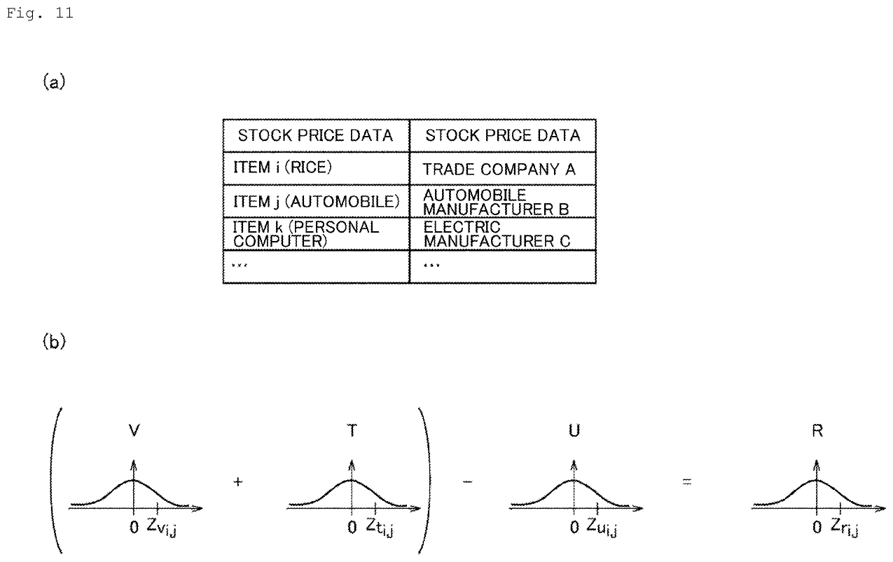

Here, the semantic similarity matrix U of the semantic similarity u_{i,j}, the waveform similarity matrix V of waveform similarity v_{i,j} related to time-series data of the price variation, and a waveform similarity matrix T of a waveform similarity t_{i,j} related to time-series data of stock price variation can be acquired. Also, a correspondence table between price data of each item (i=rice, j=automobile, k=personal computer, . . . ) and stock price data (A=trade company, B=automobile manufacturer, C=electric manufacturer, . . . ) of the company are prepared in advance (see FIG. 11(a)). Here, it is assumed that the price of the rice i is linked to the stock price of the trade company A selling the rice, and that the price of the automobile j is linked to the stock price of the automobile manufacturer B.

At this time, i of standardized variable values Zt_{i,j} related to the waveform similarity matrix T of stock price variation is replaced by A, and j is replaced by B. Thus, three indices of meaning, price and stock price related to rice can be prepared. Therefore, it is considered that the degree of unexpectedness (R) is obtained by obtaining the difference between the “waveform similarity (V, T) of the price and the stock price” and the “semantic similarity (U)” (see FIG. 11(b)).

In addition, V, T, and U can be divided by addition or subtraction. For example, since the price and the stock price have a correlation, as shown in Expression (8), the standardized variable values Zv_{i,j} of the price and the standardized variable values Zt_{i,j} of the stock price variation may be added and divided by 2, and the synthesized values Zr_{i,j} obtained by subtracting the standardized variable value Zu_{i,j} of the semantic similarity from the divided values may be used as the unexpectedness.

[Math. 8]

Zᵣ_{ᵢⱼ}=(Zᵥ_{ᵢⱼ}+Zₜ_{ᵢⱼ})/2−Zᵤ_{ᵢⱼ} (8)

### 3.4. Effects of Second Embodiment

In the second embodiment, since the same scale of the standardized variable value Z is used for the semantic similarity u_{i,j} and the waveform similarity v_{i,j}, the influence on a specific index can be suppressed. Further, since the adjustment parameter of the weight is not used, the adjustment of the weight can be made unnecessary.

In the second embodiment, since each element of the semantic similarity u_{i,j} and the waveform similarity v_{i,j} is expressed by the standardized variable value Z of the standard normal distribution, even when the scales between the indices are different, the synthesis can be properly performed.

Thus, a technique capable of appropriately synthesizing a plurality of different indices can be provided. The user can automatically calculate the accurate unexpectedness without knowing the theoretical background, thereby ensuring security. Although the degree of unexpectedness for a person is sensuous, it is difficult to evaluate, the results can be compared and used for verification by using the unexpectedness algorithm described in the second embodiment. In the future, the relative superiority or inferiority of the algorithm is evaluated by majority decision.

### 4. Third Embodiment

### 4.1. Importance of Object Items of Combination

By performing the first embodiment or the second embodiment, the unexpectedness degree matrix R having the element of the unexpectedness r_{I,j} (1≤i≤m, 1≤j≤m) can be obtained. However, when the number of items (m) increases explosively, the pair becomes {m(m−1)}/2, so that it becomes difficult for a person to list and interpret the calculation result of the degree of unexpectedness as the number of items increases. Therefore, in the third embodiment, a method of calculating the importance of the combination object items will be described in order to facilitate selection of which item among a plurality of items is important for a predetermined item.

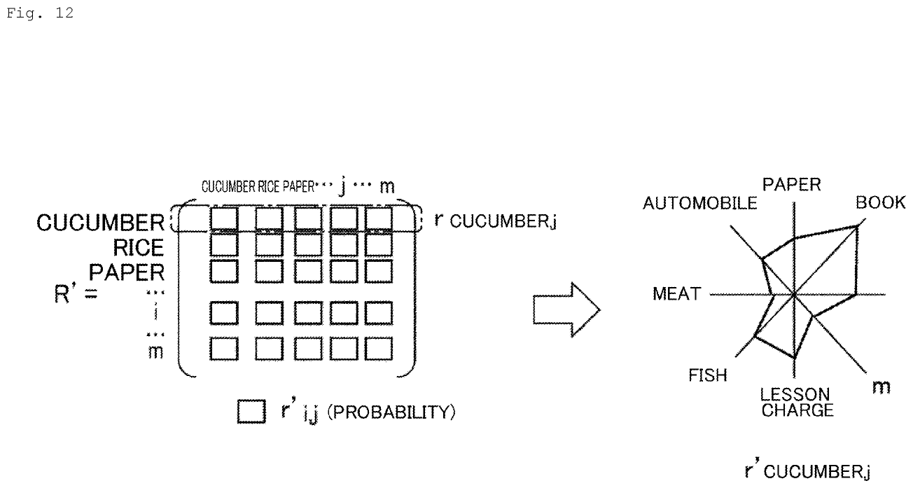

The information processing device 1 further includes an importance calculation unit for calculating the importance of the item in addition to the functional unit illustrated in FIG. 2 or FIG. 8. The importance calculation unit converts all the unexpectedness r′_{i,j} included in the unexpectedness degree matrix R obtained in the first embodiment and the second embodiment into a probability value in one row or in one column, and generates an unexpectedness matrix R′ having the degree of unexpectedness r′_{i,j} of the probability value as an element. Next, the importance calculation unit extracts, for example, the degree of unexpectedness r′_{cucumber,j} of the cucumber row from the degree of the unexpectedness degree matrix R, for the cucumber, each probability value of the degree of unexpectedness r′_{cucumber,j} is plotted on a radar chart (see FIG. 12).

Thereafter, the importance calculation unit quantifies the sharp degree of the shape of the probability distribution in the radar chart by applying Expression (9). Thus, the possibility that a certain item (cucumber in this example) depends on a specific item can be represented by a scalar.

[Math. 9]

H_{Cucumber}=−Σⱼ₌₁^{m}r′_{Cucumber,j} log r′_{Cucumber,j} (9)

H is entropy. If the H_{cucumber} is small, it suggests that the cucumber has a high value in some items. A user can use the table as a material to be interpreted as “cucumber is valuable for analysis” by checking this numerical value. For example, it can be used for establishing a sales strategy for each item such as which item should be preferentially purchased.

### 4.2. Importance of Similarity Matrix

The method for calculating the importance can be applied to ascertain the importance of the similarity matrix in addition to the importance of the object items of the combination. Since H represents a degree of uncertainty (degree of sharpness), by comparing “degree of sharpness of waveform similarity” with “degree of sharpness in semantic similarity,” which of the meaning and the waveform is significant can be ascertained.

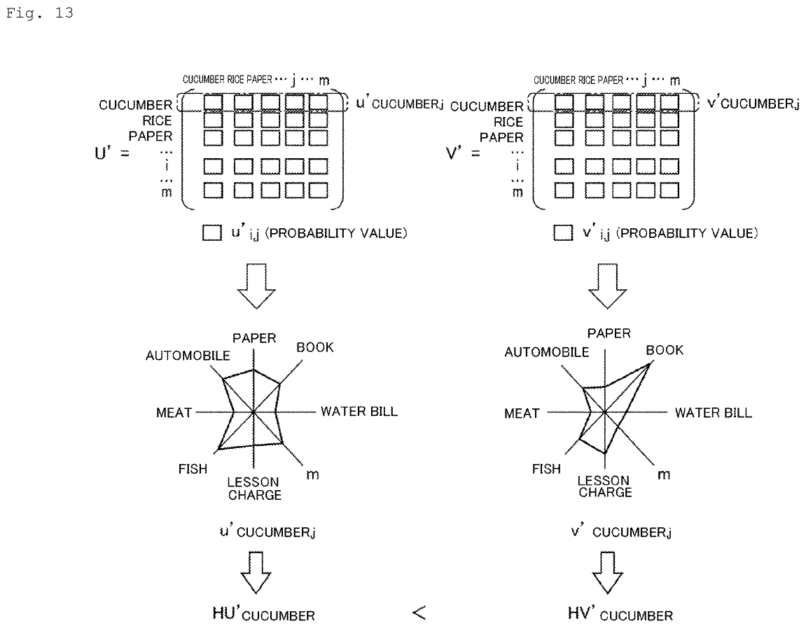

The importance calculation unit extracts semantic similarity u′_{cucumber,j} of cucumber rows from the semantic similarity matrix U′, for example, for a cucumber, and plots each probability value of the semantic similarity u′_{cucumber,j} on a radar chart (see FIG. 13). Similarly, the importance calculation unit extracts the waveform similarity v′cucumber,j of the cucumber row from the waveform similarity matrix V′, and plots each probability value of the waveform similarity v′_{cucumber,j} on a radar chart. Thereafter, the importance calculation unit applies Expressions (10) and (11) to quantize the sharpened state of the shape of the probability distribution in each radar chart.

[Math. 10]

HU′_{Cucumber}=−Σⱼ₌₁^{m}u′_{Cucumber,j} log u′_{Cucumber,j} (10)

[Math. 11]

HV′_{Cucumber}=−Σⱼ₌₁^{m}v′_{Cucumber,j} log v′_{Cucumber,j} (11)

As illustrated in FIG. 13, it is assumed that the HU′_{cucumber} do not depend on a specific item, and the HV′_{cucumber} depend on a book. In this case, it can be considered that regarding the cucumber, the importance of the semantic similarity is low but the importance of the waveform similarity is high. In this way, by comparing the value of the HU′_{cucumber} with the value of the HV′_{cucumber}, it can be used to consider the importance of the semantic similarity matrix U and the waveform similarity matrix V.

### 5. Others

The present invention is not limited to the embodiment described above. The present invention can be modified in a number of ways within the scope of the gist of the present invention.

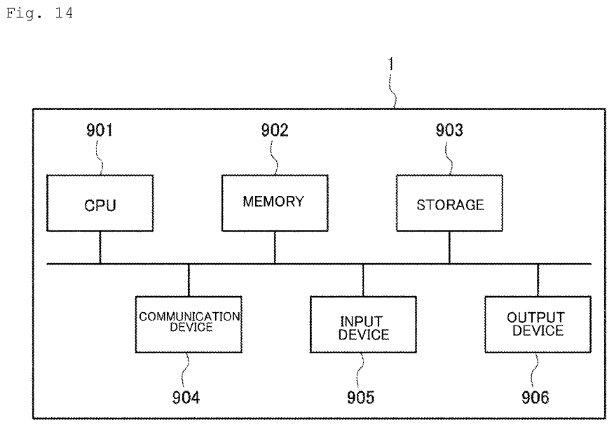

For example, the information processing device 1 of the present embodiment described above can be realized using a general-purpose computer system including a CPU 901, a memory 902, a storage 903, a communication device 904, an input device 905, and an output device 906 for example as illustrated in FIG. 14. Each of the memory 902 and the storage 903 is a storage device. In that computer system, each function of the information processing device 1 is realized by the CPU 901 executing a predetermined program loaded on the memory 902.

The information processing device 1 may be implemented as one computer. The information processing device 1 may be implemented as a plurality of computers. The information processing device 1 may be a virtual machine implemented in a computer. The program for the information processing device 1 can be stored on a computer-readable recording medium such as an HDD, an SSD, a USB memory, a CD, or a DVD. The program for the information processing device 1 can also be distributed via a communication network.

### Reference Signs List

1: Information processing device
11: Acquisition unit
12: Conversion unit
13: Calculation unit
21: Acquisition unit
22: Calculation unit
23: Determination unit
24: Conversion unit
25: Synthesis unit
26: Inverse conversion unit
27: Calculation unit
901: CPU
902: Memory
903: Storage
904: Communication unit
905: Input device
906: Output device

1. An information processing device comprising:
a calculation unit, including one or more processors, configured to calculate a degree of overlapping between a probability distribution of each probability value included in a row i or a column i of a semantic similarity matrix, and a probability distribution of respective probability values included in a row j or a column j (j≠i) of a waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

2. An information processing device comprising:
a calculation unit, including one or more processors, configured to calculate, in a case where a plurality of semantic similarities included in a semantic similarity matrix and a plurality of waveform similarities included in a waveform similarity matrix each follow a normal distribution or a Poisson distribution, a synthesized value of standardized variable values of the semantic similarity of a row i and a column j of the semantic similarity matrix and standardized variable values of the waveform similarity of the row i and the column j of the waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

3. The information processing device according to claim 2, further comprising:
a determination unit, including one or more processors, configured to determine an average value and a dispersion value of a normal distribution or a Poisson distribution related to the semantic similarity matrix and determine an average value and a dispersion value of a normal distribution or a Poisson distribution related to the waveform similarity matrix;
a conversion unit, including one or more processors, configured to convert a semantic similarity of the plurality of semantic similarities included in the semantic similarity matrix into a standardized variable value using the average value and the dispersion value related to the semantic similarity matrix, and convert a waveform similarity of the plurality of waveform similarities included in the waveform similarity matrix into a standardized variable value using the average value and the dispersion value related to the waveform similarity matrix;
a synthesis unit, including one or more processors, configured to synthesize the standardized variable value of the semantic similarity and the standardized variable value of the waveform similarity; and
an inverse conversion unit, including one or more processors, configured to inversely convert the standardized variable value after synthesis into a non-standardized variable value using the average value and the dispersion value related to the semantic similarity matrix and the average value and the dispersion value related to the waveform similarity matrix, wherein
the calculation unit is configured to calculate the standardized variable value after the synthesis which is the synthesized value, or the non-standardized variable value in place of the synthesized value as a degree of unexpectedness.

4. The information processing device according to claim 3, wherein the determination unit is configured to determine the average value and the dispersion value related to the semantic similarity matrix and the average value and the dispersion value related to the waveform similarity matrix, which are externally input, as the average value and the dispersion value to be used.

5. The information processing device according to claim 3, wherein the determination unit is configured to calculate an average value and a dispersion value of each of the semantic similarity matrix and the waveform similarity matrix using the semantic similarity matrix and the waveform similarity matrix, and determine the average value and the dispersion value to be used.

6. An information processing method performed by an information processing device, the method comprising:
calculating a degree of overlapping between a probability distribution of each probability value included in a row i or a column i of a semantic similarity matrix, and a probability distribution of respective probability values included in a row j or a column j (j≠i) of a waveform similarity matrix as a degree of unexpectedness between an i-th word and a j-th word using the semantic similarity matrix in which elements are probability values in one row or one column of a semantic similarity between words of a plurality of words and the waveform similarity matrix in which elements are probability values in one row or one column of a waveform similarity between time-series data of time-series data related to the words.

7. (canceled)

8. An information processing program which causes a computer to function as the information processing device according to claim 1.
